(19) United States
(12) Patent Application Publication
(10) Pub. No.: US 2022/0250655 A1
(43) Pub. Date: Aug. 11, 2022

(54) MOBILITY CONTROL SYSTEM, METHOD, AND PROGRAM

(71) Applicant: NEC Corporation, Minato-ku, Tokyo (JP)

(72) Inventor: Noritaka YAMASHITA, Tokyo (JP)

(73) Assignee: NEC Corporation, Minato-ku, Tokyo (JP)

(21) Appl. No.: 17/630,622

(22) PCT Filed: May 29, 2020
(86) PCT No.: PCT/JP2020/021376

§ 371 Date: Jan. 27, 2022

(30) Foreign Application Priority Data
Aug. 2, 2019 (JP) 2019-142901

(51) Int. Cl. B60W 60/00

(52) U.S. Cl. CPC B60W 60/0018; H04W 24/08; B60W 2556/45

(57) ABSTRACT

The mobility control system 80 is mounted on mobility to be controlled and performs control according to condition of the mobility. The communication state detection unit 81 detects a communication state with an external device. The control unit 82 performs the control to restrict an operating function of the mobility based on the communication state. The communication state detection unit 81 detects communication availability or communication speed status as the communication state. The control unit 82 determines the function to restrict based on the communication state.

### TECHNICAL FIELD

The present invention relates to a mobility control system, a mobility control method, and a mobility control program for performing control according to communication status of the mobility equipped with a communication function.

### BACKGROUND ART

In recent years, mobility represented by cars has been equipped with communication functions to improve comfort and safety. In addition, by connecting to the Internet, it has become possible to enjoy various information services from outside in addition to what can be realized only within the mobility internal network. In this specification, mobility is defined as meaning a transportation means (for example, a vehicle such as a car).

In particular, when an abnormality occurs in the mobility, the information necessary for various controls is collected using the communication function to ensure the safety of the mobility, and the mobility is controlled as necessary.

For example, patent literature 1 describes a system that takes action when an abnormality in communication data in an in-vehicle system occurs. The system described in patent literature 1 collects information for determining the status from each information processing device in the in-vehicle system when an abnormality in communication data occurs in the in-vehicle system, and identifies whether or not a security abnormality and a safety abnormality have occurred, respectively. Then, the above-described system determines the action to be taken for the abnormality, and notifies each information processing device thereof

Also, Patent literature 2 describes a system for diagnosing a vehicle abnormality in real time by transmitting diagnostic target data to a center device. In the system described in patent literature 2, when the diagnostic vehicle device transmits the detected diagnostic target data to the center device, the center device determines whether the event is a rare event or not, determines whether the diagnostic vehicle is abnormal or not based on the determination result, and transmits the diagnosis result to the diagnostic vehicle device.

### CITATION LIST

### Patent Literature

Patent Literature 1: Japanese Patent Laid-Open No. 2019-73102

Patent Literature 2: Japanese Patent Laid-Open No. 2013-120143

### SUMMARY OF INVENTION

### Technical Problem

On the other hand, the systems described in patent literature 1 and patent literature 2 assume that communication with the outside is properly performed. In other words, no consideration is given to the case where some abnormality or defect occurs in the communication with the outside itself Therefore, it is desirable to take appropriate measures according to the communication status even in the case that some abnormality or defect occurs in the communication with the outside when the mobility is controlled on the premise of the connection with the outside.

Therefore, it is an object of the present invention to provide a mobility control system, a mobility control method, and a mobility control program capable of performing appropriate control according to the communication status of the mobility on the premise of communication with the outside.

### Solution to Problem

A mobility control system according to the present invention is a mobility control system which is mounted on a mobility to be controlled and performs control according to condition of the mobility includes a communication state detection unit which detects a communication state with an external device, and a control unit which performs the control to restrict an operating function of the mobility based on the communication state, wherein the communication state detection unit detects communication availability or communication speed status as the communication state, and the control unit determines the function to restrict based on the communication state.

A mobility control method according to the present invention is a mobility control method which performs control according to condition of a target mobility includes detecting communication availability or communication speed status as a communication state with an external device, and performing the control to restrict an operating function of the mobility based on the communication state.

A mobility control program according to the present invention is a mobility control program applied to a computer which is mounted on a mobility to be controlled and performs control according to condition of the mobility, causes the computer to execute a communication state detection process of detecting a communication state with an external device, and a control process of performing the control to restrict an operating function of the mobility based on the communication state, wherein the mobility control program causes the computer to detect communication availability or communication speed status as the communication state, in the communication state detection process, and the mobility control program causes the computer to determine the function to restrict based on the communication state, in the control process.

### Advantageous Effects of Invention

According to the present invention, it is possible to perform appropriate control according to communication status of mobility on the premise of communication with the outside.

### BRIEF DESCRIPTION OF DRAWINGS

FIG. 1 It depicts a block diagram showing a configuration example of an exemplary embodiment of a mobility control system according to the present invention.

FIG. 2 It depicts a flowchart showing an operation example of a mobility control system.

FIG. 3 It depicts a block diagram showing an overview of a mobility control system according to the present invention.

### DESCRIPTION OF EMBODIMENTS

Hereinafter, exemplary embodiments of the present invention are described with reference to the drawings.

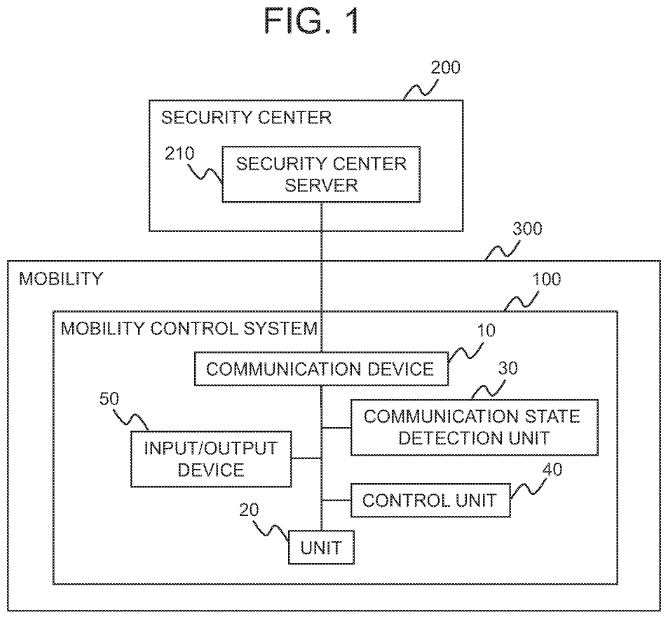

FIG. 1 is a block diagram showing a configuration example of an exemplary embodiment of a mobility control system according to the present invention. The mobility control system 100 of this exemplary embodiment includes a communication device 10, a unit 20, a communication state detection unit 30, a control unit 40, and an input/output device 50.

The mobility control system 100 is a system that is mounted on a mobility 300 to be controlled and takes actions according to the state of the mobility 300. A connected car is a specific example of the mobility 300. In this exemplary embodiment, an automatic driving car using a communication function is assumed, and various functions of an automatic driving car that uses a GPS (Global Positioning System), road-mounted device, the Internet, and the like will be described as specific examples. However, the mobility 300 is not restricted to a car, and may be, for example, a train, an aircraft, and the like.

The mobility control system 100 communicates with a security center server 210 in the external security center 20 through the communication device 10. The security center server 210 transmits various information necessary for controlling the mobility to the mobility control system 100.

The communication device 10 is specifically a device that communicates with the security center server 210 or any external server (not shown). The mode of the communication device 10 is arbitrary, and is realized, for example, by a communication device equipped with a module dedicated for in-vehicle use. The communication device 10 may notify the communication status to the communication state detection unit 30 described below, and may also notify detected abnormalities and defects.

The unit 20 is a unit that detects various states of the mobility and performs control, and is realized, for example, by various electronic control units (ECU: Electronic Control Unit). Although only one unit 20 is illustrated in FIG. 1, the number of units 20 is not limited to one, and may be two or more. The mobility control system 100 includes a plurality of units 20 according to a control target. For example, in the case of a car, the control target includes an engine, a brake, a meter, a car navigation system, an airbag, and the like.

The communication state detection unit 30 detects the communication state with the external device. Specifically, the communication state detection unit 30 detects the communication state with the security center server 210 and the external server by the communication device 10. The communication state detection unit 30 may detect the communication state by periodically inquiring the state from the communication device 10, or it may detect the communication state based on the communication status notified by the communication device 10. Also, the communication state detection unit 30 may detect invalid packets (values, replays, etc.) in the CAN (Controller Area Network).

The communication state detection unit 30 detects at least one of communication availability, communication speed status, and unauthorized communication as the communication state. In doing so, the communication state detection unit 30 may collect various status information of the mobility 300 to identify the location where an abnormality or a defect has occurred.

Examples of a status in which communication is not possible include a status in which communication is being disconnected, authentication with an outside is in progress, a communication device is malfunctioning, or a communication error has occurred. Examples of statuses in which the communication speed is reduced (communication is restricted) include congestion, low-speed communication mode, and the like.

Examples of statuses in which unauthorized communication is taking place include a Denial of Service attack (DoS), abnormal communication from within mobility, unusual processing and the like. For example, a different process than usual is occurring, a specific process is accessing a different file than usual, a different IP address or port than usual is being used, or an invalid ID and password is being used for access, and so on.

The control unit 40 performs control to restrict the operating functions of the mobility 300 based on the communication state detected by the communication state detection unit 30. Specifically, the control unit 40 determines a function to be restricted based on the communication state, and performs various controls for the determined function. For example, if the mobility is a connected car that performs automatic driving, the control unit 40 performs control of the automatic driving that can be realized with the restricted functions.

When a status in which communication is not possible is detected, the control unit 40 performs the control to restrict to the function that do not perform the communication among functions installed in the mobility 300. For example, in the case of automatic driving, the control unit 40 performs control of automatic driving that can be realized with the functions that do not perform communication. The automatic driving-related functions that do not perform communication include functions using a short-range sensor and some car operation functions, such as a distance measurement and maintenance function, a lane departure correction function, a collision avoidance function, a parking support function, and an equipment detection function.

When a status in which the communication speed is decreasing is detected, the control unit 40 performs the control to restrict the function in which an assumed amount of communication exceeds a predetermined standard among functions installed in the mobility 300. For example, in the case of automatic driving, the control unit 40 restricts functions so that automatic driving and services that require a large amount of communication are not performed, and performs control of the automatic driving that can be realized with functions for which the assumed amount of communication does not exceed the predetermined standard. Examples of functions requiring a large amount of communication include dynamic maps, video data transmission (such as remote control functions), upload/download functions for detailed car data and logs, and the like.

Functions for which the assumed amount of communication does not exceed a predetermined standard (functions that can be achieved with less communication) include a vehicle position information notification function (GPS), a function for distributing car data in the form of status (running, stopped, malfunctioning etc.), an emergency call function that requests an SOS from the driver to the cloud side, and an abnormality detection alert function that notifies whether or not an abnormality has occurred.

That is, when a status in which the communication speed is reduced is detected, the control unit 40 may control to enable a function that can be realized with less communication as described above and to disable a function that requires a large amount of communication. In such a case, the selectable functions may be defined according to the limited amount of communication, and the control unit 40 may select the function to be operated according to the communication speed. Also, the priority of the function to be operated may be predetermined, and the control unit 40 may determine the function according to the priority within the range of the allowable amount of communication.

When a status in which unauthorized communication is detected, the control unit 40 may determine that the status is one in which appropriate control cannot be performed, and may perform control to restrict functions such as automatic determination. For example, in the case of automatic driving, the control unit 40 may perform control to stop the automatic driving itself

In addition, the control unit 40 may also block specific addresses or specific ports, block all networks, stop or restart processes, delete or update files, and restart or update communication units.

The control unit 40 may also collect information on the occurrence of the abnormality from the intra-mobility network and analyze the cause of the abnormality. Then, depending on the cause of the abnormality, the control unit 40 may take action against the cause, implement Over the Air (OTA), recover functions reduced by the immediate action, reduce maintaining the operation, and the like may be performed. Further, the control unit 40 may notify the security center server 210 (for example, SOC: Security Operation Center), the driver's mobile terminal, and the input/output device 50 described below of the communication state.

The input/output device 50 is a device for performing input/output processing between an operator of the mobility 300 and the mobility control system 10. The input/output device 50 is realized, for example, by an IVI (in-vehicle infotainment). The input/output device 50 may display on the screen of the IVI that an abnormality has occurred in response to an instruction from the control unit 40.

The communication state detection unit 30 and the control unit 40 are realized by a processor of a computer (for example, a CPU (Central Processing Unit), or a GPU (Graphics Processing Unit)) that operates according to a program (mobility control program).

For example, the program may be stored in a storage unit (not shown) comprised by the mobility control system 100, and the processor may read the program and, operate as the communication state detection unit 30 and the control unit 40 according to the program. Also, the functions of the mobility control system 100 may be provided in a SaaS (Software as a Service) format.

The communication state detection unit 30 and the control unit 40 may each be realized by dedicated hardware. Some or all of the components of each device may be realized by general-purpose or dedicated circuitry, processors, or combinations thereof. These may comprise a single chip or a plurality of chips connected through a bus. Some or all of the components of each device may be realized by a combination of the above-described circuits, etc. and a program.

When some or all of each component of the mobility control system 100 is realized by a plurality of information processing devices, circuits, or the like, the plurality of information processing devices, circuits, or the like may be centrally located or distributed.

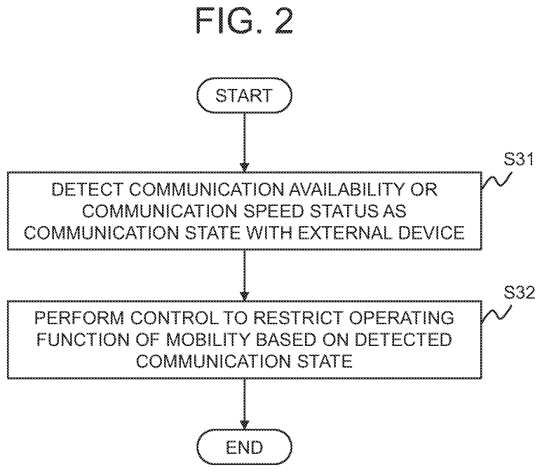

Next, an operation example of this exemplary embodiment will be described. FIG. 2 is a flowchart showing an operation example of the mobility control system 100 of this exemplary embodiment. The communication state detection unit 30 detects the communication availability or the communication speed status as a communication state with an external device (step S11). The control unit 40 performs control to restrict an operating function of the mobility based on the detected communication state (step S12).

As described above, in the present exemplary embodiment, the communication state detection unit 30 detects the communication availability or communication speed status as the communication state with the external device, and the control unit 40 performs the control to restrict the operating function of the mobility based on the communication state. Thus, it is possible to perform appropriate control according to the communication status of the mobility on the premise of the connection with the outside.

Next, specific usage examples of the mobility control system 100 of this exemplary embodiment will be described. When the mobility control system 100 is installed in a car (connected car) that can be connected to the Internet, as described above, a first usage example is to respond to a cyber attack. This is because the car becomes a target of cyber-attacks when it is connected to the Internet, and the car may be illegally operated from the outside.

In this case, if the communication state detection unit 30 detects, for example, a sign of a cyber attack from the log of the communication device, the control unit 40 may block the connection to the Internet or notify the driver or call center. This makes it possible to prevent hacking of a car by a cyber attack or an accident.

A second usage example is to detect and handle failures in connected cars. For example, if an automatic driving is continued in a status where the brakes and engine cannot be controlled appropriately, it may lead to an accident involving human lives. In this case, when the communication state detection unit 30 detects a sign of a failure based on an abnormality of a communication function or an abnormality of a network in the car, the control unit 40 prompts the driver to stop the car or notify the driver or the call center. This also makes it possible to prevent unexpected behavior based on an abnormal condition or an accident caused by the behavior that has occurred.

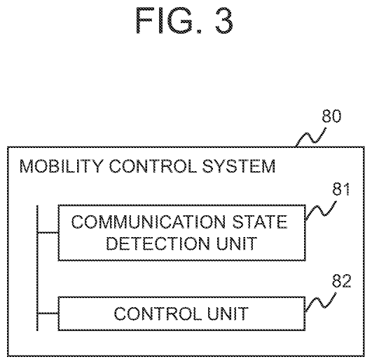

Next, an overview of the present invention will be described. FIG. 3 is a block diagram showing an overview of a mobility control system according to the present invention. The mobility control system 80 according to the present invention is a mobility control system (for example, mobility control system 100) which is mounted on a mobility (for example, mobility 300) to be controlled and performs control according to condition of the mobility includes a communication state detection unit 81 (for example, communication state detection unit 30) which detects a communication state with an external device (for example, security center server 210 or external server), and a control unit 82 (for example, control unit 40) which performs the control to restrict an operating function of the mobility based on the communication state.

The communication state detection unit 81 detects communication availability or communication speed status as the communication state, and the control unit 82 determines the function to restrict based on the communication state.

With such a configuration, it is possible to perform appropriate control according to communication status of mobility on the premise of communication with the outside.

The communication state detection unit 81 may detect the status in which communication with the external device is not possible as the communication state, and the control unit 82 may perform the control to restrict to the function that do not perform the communication among functions installed in the mobility when the communication state detection unit 81detects the status in which the communication is not possible.

The mobility may be a connected car which performs automatic driving. In this case, the control unit 82 may perform the control of the automatic driving that can be realized by the function that do not perform the communication.

On the other hand, the communication state detection unit 81 may detect the status in which the communication speed is decreasing as the communication state, and the control unit 82 may perform the control to restrict the function (for example, dynamic map, etc.) in which an assumed amount of communication exceeds a predetermined standard when the communication state detection unit detects the status in which the communication speed is decreasing.

In the case where the mobility is a connected car which performs automatic driving, the control unit 82 may perform the control of the automatic driving that can be realized by the function in which the assumed amount of communication does not exceed the predetermined standard among functions installed in the mobility.

The mobility control system 80 according to the present invention may consider unauthorized communication in addition to the communication availability or the communication speed status as the communication state. That is, the communication state detection unit 81 may detect at least one of the communication availability, the communication speed status, and the unauthorized communication as the communication state, and the control unit 82 may determine the function to restrict based on the communication state.

In this case, the communication state detection unit 81 may detect that the communication state is under a DoS attack, that abnormal communication is being performed from within the mobility, or that a status in which processing differ from the expected processing is being performed is detected as a communication state, and the control unit 82 may perform the control to restrict the function of automatically making decisions.

Here, the process that is different from normal may be at least one of a process that generates a process that is different from a process that is assumed in advance, a process in which a specific process accesses a file that is different from a file that is assumed in advance, a process that is accessing an IP address or a port that is different from the pre-assumed IP address or port, or a process that is accessing a file with an invalid ID or password.

If the mobility is a connected car that performs automatic driving, the control unit 82 may perform the control to stop the automatic driving itself

Some or all of the above exemplary embodiments may also be described in the following supplementary notes, but are not limited to.

(Supplementary note 1) A mobility control system which is mounted on a mobility to be controlled and performs control according to condition of the mobility comprising:

a communication state detection unit which detects a communication state with an external device, and

a control unit which performs the control to restrict an operating function of the mobility based on the communication state, wherein

the communication state detection unit detects communication availability or communication speed status as the communication state, and

the control unit determines the function to restrict based on the communication state.

(Supplementary note 2) The mobility control system according to Supplementary note 1, wherein

the communication state detection unit detects the status in which communication with the external device is not possible as the communication state, and

the control unit performs the control to restrict to the function that do not perform the communication among functions installed in the mobility when the communication state detection unit detects the status in which the communication is not possible.

(Supplementary note 3) The mobility control system according to Supplementary note 2, wherein

the mobility is a connected car which performs automatic driving, and

the control unit performs the control of the automatic driving that can be realized by the function that do not perform the communication.

(Supplementary note 4) The mobility control system according to Supplementary note 1, wherein

the communication state detection unit detects the status in which the communication speed is decreasing as the communication state, and

the control unit performs the control to restrict the function in which an assumed amount of communication exceeds a predetermined standard when the communication state detection unit detects the status in which the communication speed is decreasing.

(Supplementary note 5) The mobility control system according to Supplementary note 4, wherein

the mobility is a connected car which performs automatic driving, and

the control unit performs the control of the automatic driving that can be realized by the function in which the assumed amount of communication does not exceed the predetermined standard among functions installed in the mobility.

(Supplementary note 6) A mobility control method which performs control according to condition of a target mobility comprising:

detecting communication availability or communication speed status as a communication state with an external device, and

performing the control to restrict an operating function of the mobility based on the communication state.

(Supplementary note 7) The mobility control method according to Supplementary note 6, wherein

detecting the status in which communication with the external device is not possible as the communication state, and

performing the control to restrict to the function that do not perform the communication among functions installed in the mobility when the status in which the communication is not possible is detected.

(Supplementary note 8) The mobility control method according to Supplementary note 6, wherein

detecting the status in which the communication speed is decreasing as the communication state, and

performing the control to restrict the function in which an assumed amount of communication exceeds a predetermined standard when the status in which the communication speed is decreasing is detected.

(Supplementary note 9) A mobility control program applied to a computer which is mounted on a mobility to be controlled and performs control according to condition of the mobility, causing the computer to execute:

a communication state detection process of detecting a communication state with an external device, and

a control process of performing the control to restrict an operating function of the mobility based on the communication state, wherein

the mobility control program causes the computer to detect communication availability or communication speed status as the communication state, in the communication state detection process, and

the mobility control program causes the computer to determine the function to restrict based on the communication state, in the control process.

(Supplementary note 10) The mobility control program according to Supplementary note 9, wherein

the mobility control program causes the computer to detect status in which communication with the external device is not possible as the communication state, in the communication state detection process, and

the mobility control program causes the computer to restrict to the function that do not perform the communication among functions installed in the mobility when the status in which the communication is not possible is detected in the communication state detection process, in the control process.

(Supplementary note 11) The mobility control program according to Supplementary note 9, wherein

the mobility control program causes the computer to detect the status in which the communication speed is decreasing as the communication state, in the communication state detection process, and

the mobility control program causes the computer to restrict the function in which an assumed amount of communication exceeds a predetermined standard when the status in which the communication speed is decreasing is detected in the communication state detection process, in the control process.

Although the present invention has been described with reference to the foregoing exemplary embodiments and examples, the present invention is not limited to the foregoing exemplary embodiments and examples. Various changes understandable by those skilled in the art can be made to the structures and details of the present invention within the scope of the present invention.

This application is based upon and claims the benefit of priority from Japanese patent application No. 2019-142901, filed on Aug. 2, 2019, the disclosure of which is incorporated herein in its entirety by reference.

### REFERENCE SIGNS LIST

10 Communication device

20 Unit

30 Communication state detection unit

40 Control unit

50 Input/output device

100 Mobility control system

200 Security center

210 Security center server

300 Mobility

What is claimed is:

1. A mobility control system which is mounted on a mobility to be controlled and performs control according to condition of the mobility, the mobility control system comprising:
a memory storing instructions; and
one or more processors configured to execute the instructions to:
detect communication availability or communication speed status with an external device as a communication state;
determine an operating function to restrict based on the communication state; and
perform the control to restrict the operating function of the mobility.

2. The mobility control system according to claim 1, wherein the processor further executes instructions to:
detect non-communication status with the external device as the communication state; and
perform the control to restrict, among functions installed in the mobility, to the function that do not perform the communication when the non-communication status is detected.

3. The mobility control system according to claim 2, wherein
the mobility is a connected car which performs automatic driving, and
the processor further executes instructions to perform the control of the automatic driving that can be realized by the function that do not perform the communication.

4. The mobility control system according to claim 1, wherein the processor further executes instructions to:
detect the status of the communication speed reduction as the communication state; and
perform the control to restrict the function in which an assumed amount of communication exceeds a predetermined standard when the status of the communication speed reduction is detected.

5. The mobility control system according to claim 4, wherein
the mobility is a connected car which performs automatic driving, and
the processor further executes instructions to perform the control of the automatic driving that can be realized by the function in which the assumed amount of communication does not exceed the predetermined standard among functions installed in the mobility.

6. A mobility control method which performs control according to condition of a target mobility comprising:
detecting communication availability or communication speed status as a communication state with an external device; and
performing the control to restrict an operating function of the mobility based on the communication state.

7. The mobility control method according to claim 6, wherein
detecting non-communication status with the external device as the communication state, and
performing the control to restrict, among functions installed in the mobility, to the function that do not perform the communication when the non-communication status is detected.

8. The mobility control method according to claim 6, wherein
detecting the status of the communication speed reduction as the communication state, and
performing the control to restrict the function in which an assumed amount of communication exceeds a predetermined standard when the status of the communication speed reduction is detected.

9. A non-transitory computer readable information recording medium storing a mobility control program applied to a computer which is mounted on a mobility to be controlled and performs control according to condition of the mobility, when executed by a processor, the mobility control program performs a method for:
detecting communication availability or communication speed status with an external device as a communication state;
determining an operating function to restrict based on the communication state; and
performing the control to restrict the operating function of the mobility.

10. The non-transitory computer readable information recording medium according to claim 9, wherein
detecting non-communication status with the external device as the communication state, and
performing the control to restrict, among functions installed in the mobility, to the function that do not perform the communication when the non-communication status is detected.

11. The non-transitory computer readable information recording medium according to claim 9, wherein
detecting the status of the communication speed reduction as the communication state, and
performing the control to restrict the function in which an assumed amount of communication exceeds a predetermined standard when the status of the communication speed reduction is detected.
